(19) United States
(12) Patent Application Publication
(10) Pub. No.: US 2015/0227910 A1
(43) Pub. Date: Aug. 13, 2015

(54) METHOD AND SYSTEM FOR FACILITATING MICRO-TRANSACTIONS

(71) Applicant: TIBDIT LIMITED, London (GB)

(72) Inventor: Justin MAXWELL, London (GB)

(21) Appl. No.: 14/619,780

(22) Filed: Feb. 11, 2015

Related U.S. Application Data
(60) Provisional application No. 61/938,980, filed on Feb. 12, 2014.

(51) Int. Cl. G06Q 20/22; G06Q 20/38; G06Q 20/40

(52) U.S. Cl. CPC G06Q 20/29; G06Q 20/40; G06Q 20/383

(57) ABSTRACT

The present invention relates to method of facilitating micro-transaction payments. The method includes the steps of receiving a payee identifier at a device; and actuating payment of a payment amount to the payee using the payee identifier in response to a first action by a user at the device. The payment amount is predefined by the user prior to receipt of the payee identifier by the device. A system for facilitating micro-transaction payments is also disclosed.

### FIELD OF INVENTION

The present invention is in the field of micro-transactions. More particularly, but not exclusively, the present invention relates to facilitating micro-transaction payments.

### BACKGROUND

One of the major questions for providers of content or services in the online realm is how to monetise.

Some options for monetisation include using advertising, subscription models, or micro-payments.

However, the use of micro-payments present several problems: cost per individual transaction, difficulties in pricing individual items of content/services, consumer perception of being nickel-and-dimed, difficulties of global market pricing, and user resistance to complex and unpredictable pricing.

There have been many online providers of micro-payment solutions. None of these have solved all of the above problems and many of these solutions have ceased operations. Some of these providers include: Beenz, flooz, eCash Digicash, CyberCash/CyberCoin, Tipjoy, twitpay.me, tipit.to, and twippr.

The only apparent successful providers of non-subscription (casual) micro-transaction payments operate within walled gardens and include iTunes' 99 c per track pricing model and Linden Dollars. Neither of these providers can be generalised to facilitate micro-transaction payments across different content or service providers.

Therefore, there is a desire for an improved system which facilitates micro-transaction payments. It would also be desirable if this improved system could facilitate micro-transaction payments for both online and offline products and services, and also provide for gratuity-style payments. One system for providing gratuity-style micro-payments called Gittip is known, but Gittip is configured to provide micro-payments only within a subscription model.

It is an object of the present invention to provide an improved system for facilitating micro-transactions which overcomes the disadvantages of the prior art, or at least provides a useful alternative.

### SUMMARY OF THE INVENTION

According to a first aspect of the invention there is provided a method of facilitating micro-transaction payments, including:
a) receiving a payee identifier at a device;
b) actuating payment of a payment amount to the payee using the payee identifier in response to a first action by a user at the device;

wherein the payment amount is predefined by the user prior to receipt of the payee identifier by the device.

The first action may be a single action.

The method may further including the step of: prior to the first action, the device transmitting the payee identifier at a payment server in response to a second action by the user. Furthermore, response to receipt of the payee identifier by the payment server, information relating to the payment may be transmitted from the payment server to the device for display to the user.

The payment may be actuated in no more than two actions by the user.

The user of the device may initiate receipt of the payee identifier.

The payee identifier may be encapsulated within a webpage received from a server.

The payee identifier may be encapsulated within an electronically readable tag.

The electronically readable tag may be a visual code and the device may capture the visual code via a visual capture apparatus. The visual code may be a 2D barcode.

The method may further include the step of: the user at a device accessing a payment server to pre-define the payment amount.

The payment amount may be retrieved from a payment account associated with the user. The method may further include the step of: the user at a device accessing a payment server to initiate the payment account.

The method may further include the step of: the user at a device accessing a payment server to charge the payment account with funds. The user may define the funds to charge the payment account with as a multiple of the predefined payment amounts. The user may pre-define the payment amount near the time of funds transferral.

Steps (a) to (b) of the method may be repeated for a plurality of payees and the payment amount is the same value for each payment.

The method may further include the step of: a payment server transferring a token to the device confirming payment.

The method may further include the steps of: the device transferring the token to the payee; and the payee providing services to the user via the device in response to receipt of the token. The method may further include the steps of: the device transferring the token to the payee; the payee verifying the token; and the payee providing services to the user via the device in response to successful verification. The services may include provision of electronic content. The token may be digitally signed and verification may include verifying the digital signature. The user may be able to reuse the token by retransmission to the payee.

A payment server preferably accumulates a plurality of payments from a plurality of users to a payee and transfers funds to an account of the payee in a block transfer. The funds may exclude a commission fee.

During actuation of payment, the user may be authenticated by a payment server.

The payments may be processed between the accounts of the user and the payee at the server via a crypto-currency.

The payments may be processed between the accounts of the user and the payee at the server via a proprietary currency.

The payee identifier may be transmitted by the payee to the user.

The payee identifier may include a service identifier.

The payee identifier may include a payment channel identifier.

The payee identifier may include information identifying services which may include a URL identifying electronic content.

The payee identifier may be encoded in a URL.

The value of each payment amount received by a payee from a plurality of users may be anonymised from the perspective of the payee.

According to a further aspect of the invention there is provided a system for facilitating micro-transaction payments, including:
a device configured to receive a payee identifier and actuate payment of a payment amount to the payee using the payee identifier in response to a first action from a user of the device; and
a payment server configured to transfer payments from an account of the user to an account of the payee in response to instructions from the device;
wherein the payment amount is predefined by the user prior to receipt of the payee identifier by the device.

Other aspects of the invention are described within the claims.

### BRIEF DESCRIPTION OF THE DRAWINGS

Embodiments of the invention will now be described, by way of example only, with reference to the accompanying drawings in which:

FIG. 1: shows a block diagram illustrating a system in accordance with an embodiment of the invention;

FIG. 2: shows a flow diagram illustrating a method in accordance with an embodiment of the invention;

FIG. 3: shows a block diagram illustrating communications between parties of the system in accordance with an embodiment of the invention;

FIGS. 4a, 4b, and 4c: show flow diagrams illustrating methods in accordance with an embodiment of the invention; and

FIGS. 5a, 5b, 5c, and 5d: show block diagrams illustrating a deployment architecture in accordance with an embodiment of the invention.

### DETAILED DESCRIPTION OF PREFERRED EMBODIMENTS

The present invention provides an improved method and system for facilitating micro-transaction payments.

The inventor has perceived that the major barrier for consumers of content and services to use micro-transactions is psychological. That is, there are emotional issues for the consumer around value and the mental cost of making a decision to pay a prescribed but trivial amount reinforces a barrier to concluding a transaction.

Accordingly, the inventor has devised a method and system for facilitating micro-transaction payments where the consumer (the user) predefines a payment amount that they are willing to pay to access content, to pay for a service, or to pay as a gratuity. This predefined payment amount is then used for a plurality of subsequent transactions with a plurality of providers. Therefore, the issues of value are resolved as the consumer has pre-assigned a value for all transactions and the mental barriers for payment are circumvented as there is no prompting of the user for an amount when providing content/services.

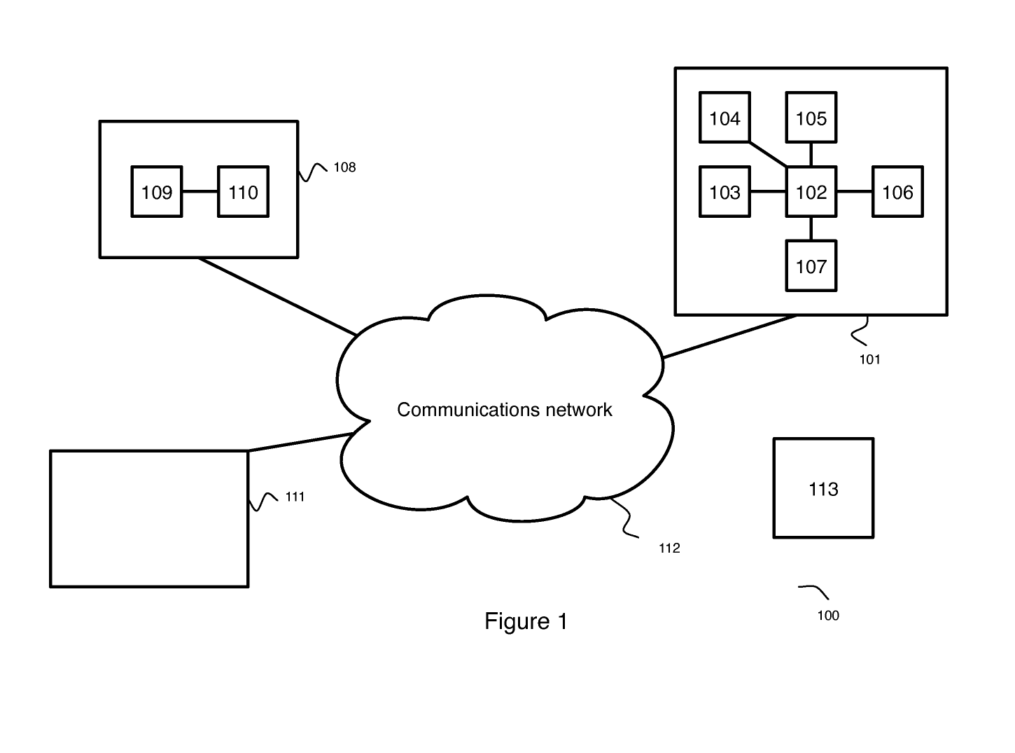

In FIG. 1, a system 100 in accordance with an embodiment of the invention is shown.

A device 101 is shown. The device 101 is a user device such as a computing device, a mobile device (such as a smartphone or tablet), or single purpose device.

The device 101 may include a processor 102, a memory 103, a communications module 104, an input 105, a display 106, and an electronic tag capture apparatus 107.

The electronic tag capture apparatus 107 may be an NFC-reader, a camera for reading visual codes such as barcodes or 2D visual codes, or any other apparatus capable of capturing or receiving an electronic tag.

A payment server 108 is shown. The payment server 108 may include a processor 109 and a communications module 110.

In the present embodiment, a payee apparatus 111 associated with a payee (who may be a content or service provider) is also shown. The payee apparatus 111 may be a web server configured to deliver web pages to the device 101 upon request.

The device 101, payment server 108, and payee apparatus 111 may be connected, to facilitate communications between them, via a communications network 112.

The device 101 may be configured for receiving a payee identifier 113. For example, the electronic tag capture apparatus may read a payee identifier 113 from the physical world (such as an NFC tag or visual code), or the communications module 104 of the device 101 may receive the payee identifier 113 encoded within an electronic message, such as a URL, from the payee apparatus 111. The device 101 may be configured to receive the payee identifier 113 within a web browser. For example, the payee identifier may be embedded within a web page transmitted to the device 101 by the payee apparatus.

The device 101 may be further configured for requesting that payment is made to the payee in response to an action via the input 105 from the user of the device 101. The payment request may be sent to the payment server 108. The action may be the clicking of a button or link. It will be appreciated that the term “clicking” covers mouse or trackpad input, or touchscreen or gesture-based interfaces. In one embodiment, only a single action is required to actuate payment. In an alternative embodiment, only two actions are required to actuate payment, with the prior action displaying confirmation of the amount of payment and/or the payee.

The payment server 108 may be configured for allocating a payment amount from the user to the payee in response to the request, for combining a plurality of payments for the payee into a single block (the plurality of payments may come from a plurality of users) and for transferring the payments to the payee in a block. The payment server 108 may also be configured to retrieve payment details for the payee from the payment identifier 113. The payment amount may be pre-defined by the user prior to receipt of the payee identifier 113 and may be set at that predefined amount for a plurality of subsequent payments to a plurality of payees.

The payment server 108 may be further configured for transmitting confirmation of payment to the payee apparatus 111. The transmission may occur via the device 101.

The confirmation of payment may be a token digitally signed and/or encrypted by the payment server 108.

The payee apparatus 111 may be configured to deliver content or services, or to provide confirmation of successful payment to the device 101. In one embodiment, the payee apparatus 111 delivers content/services only upon successful receipt and/or verification of the confirmation of payment from the payment server 108.

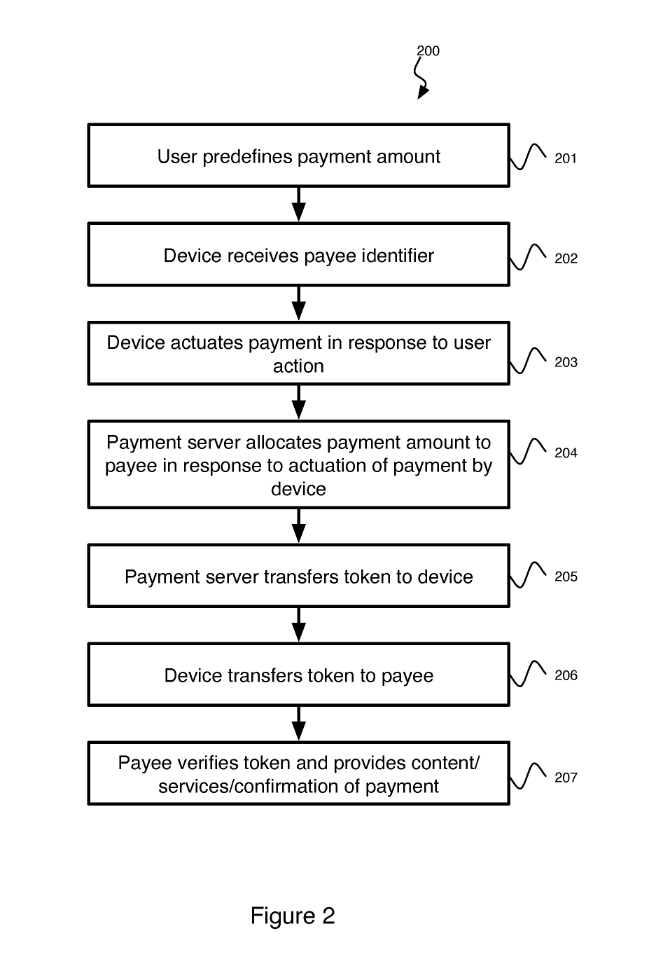

A method 200 in accordance with an embodiment of the invention will now be described with reference to FIG. 2.

In step 201, a user predefines a set payment amount at the payment server. The user may first establish an account with the payment server. The user may also then transfer funds to the account.

In step 202, the device receives a payee identifier. The device may receive the payee identifier at the request of the user of the device. For example, the user may request a web-page from the payee apparatus which may include a widget or URL incorporating the payee identifier. In an alternative embodiment, the user may actuate capture of a physical electronic tag by the device, the electronic tag incorporating the payee identifier.

The payee identifier may include payment information for the payee. For example, the payment information may be a bitcoin account, paypal account or bank account. The payee identifier may also include information about the payee and about the purpose for the payment. For example, the purpose of the payment may identify specific content or services of the payee.

In step 203, the device actuates payment of the predefined payment amount to the payee in response to an action from the user. For example, the user may click a button displayed by the widget, or click the URL displayed in the webpage.

In one embodiment, payment may be actuated in response to only a single action from the user. In an alternative embodiment, payment is not actuated until the payment server displays confirmatory information about the amount of payment and the payee details to the user, and another confirmatory action is received from the user (i.e. such that two actions are received by the user before payment is actuated).

In step 204, the payment server may receive the actuation of payment request from the device. In response to the request, the payment server may allocate the payment amount from the user's account for transfer to the payee. A commission fee may be taken from the payment amount before transfer to the payee. Transfer to the payee may be made immediately or may be bundled into a block of payments to the payee, for example, from a plurality of users.

In step 205, the payment server may transfer a token to the device confirming payment. The token may include one or more of the payee identifier, a timestamp, a payment identifier, and a unique token identifier. The token may be digitally signed with a key of the payment server. In one embodiment, the token may be encrypted, for example, with a public key for the payee.

In step 206, the device may transfer the received token to the payee apparatus.

In step 207, the payee apparatus may verify the token, for example, by checking the digital signature and provide content, services or confirmation of payment to the user and/or device. In one embodiment, the payee apparatus utilises the payment server to process verification of the token. In an alternative embodiment, the payee apparatus does not verify the token but provides content/services/confirmation in response to simple receipt of the token.

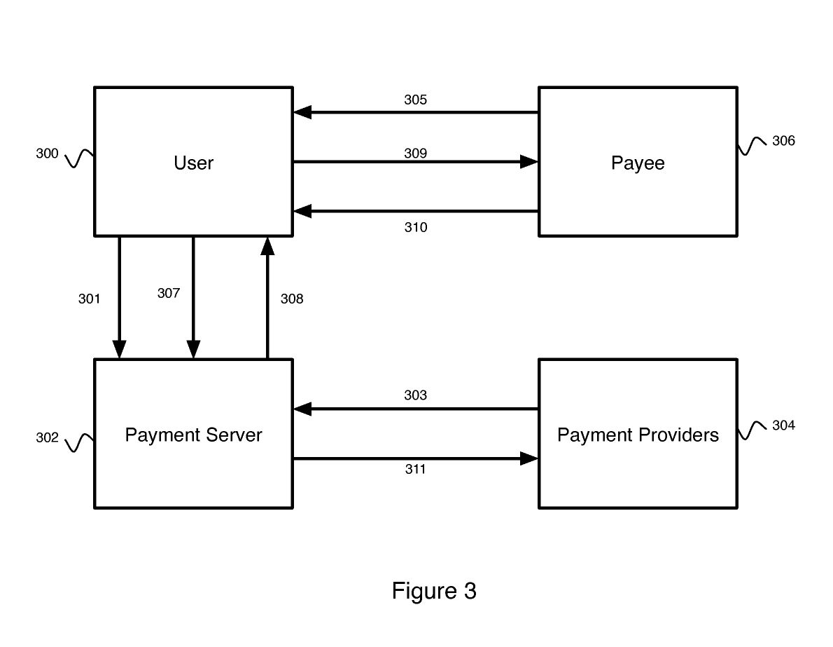

In FIG. 3, a block diagram shows communications between the parties of the system in accordance with an embodiment of the invention.

The user 300 communicates 301 with the payment server 302 to predefine a payment amount and to coordinate transfer of funds to the account of the user.

The payment server 302 receives 303 funds from the user's payment provider 304.

The user 300 receives 305 a payee identifier from the payee 306.

The user 300 requests 307 that the payment server 302 pay the payee 306.

A token is transmitted 308 from the payment server 302 to the user 300.

The user 300 transmits 309 the token to the payee 306.

The payee 306 may verify the token and provide 310 access to content or services or confirmation of payment to the user.

The payment server 302 accumulates a plurality of payments to the payee 306 and transfers 311 the payments in a block in accordance with the payment information within the payee identifier.

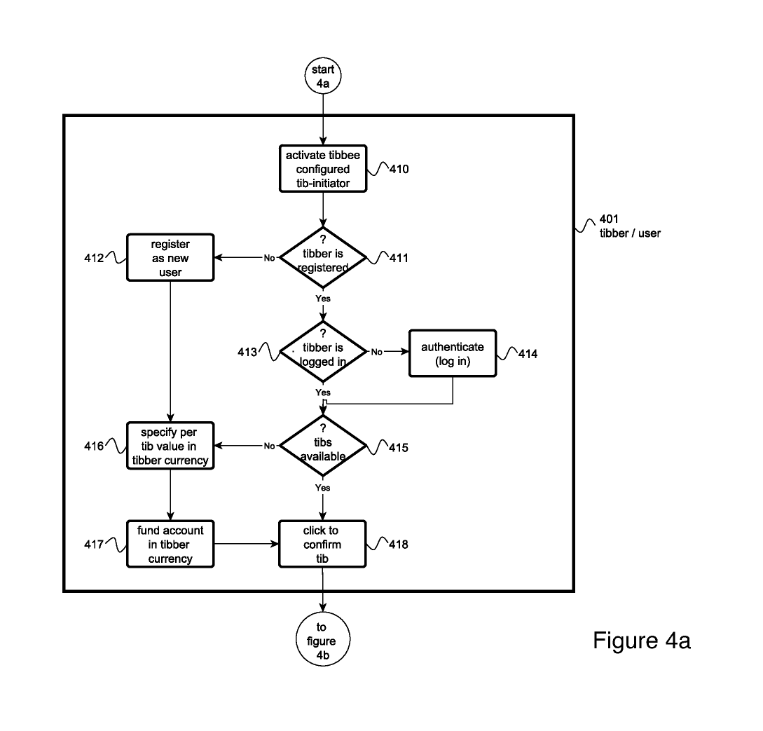

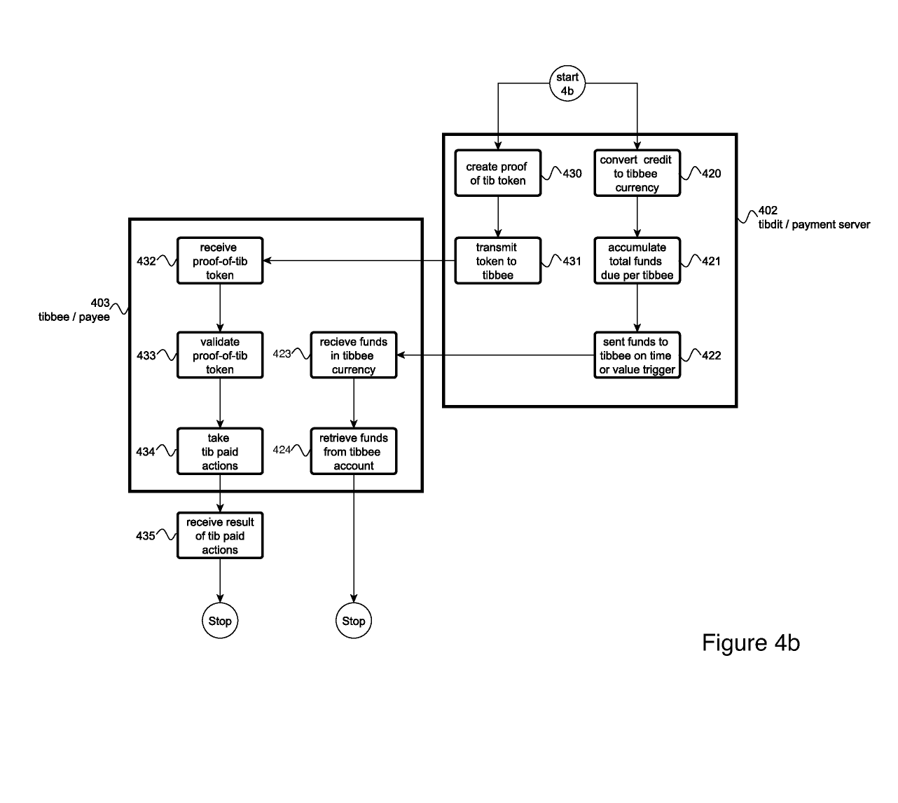

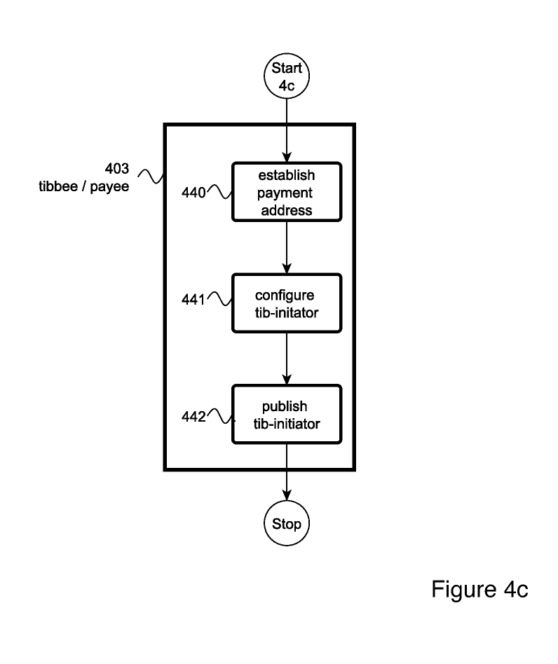

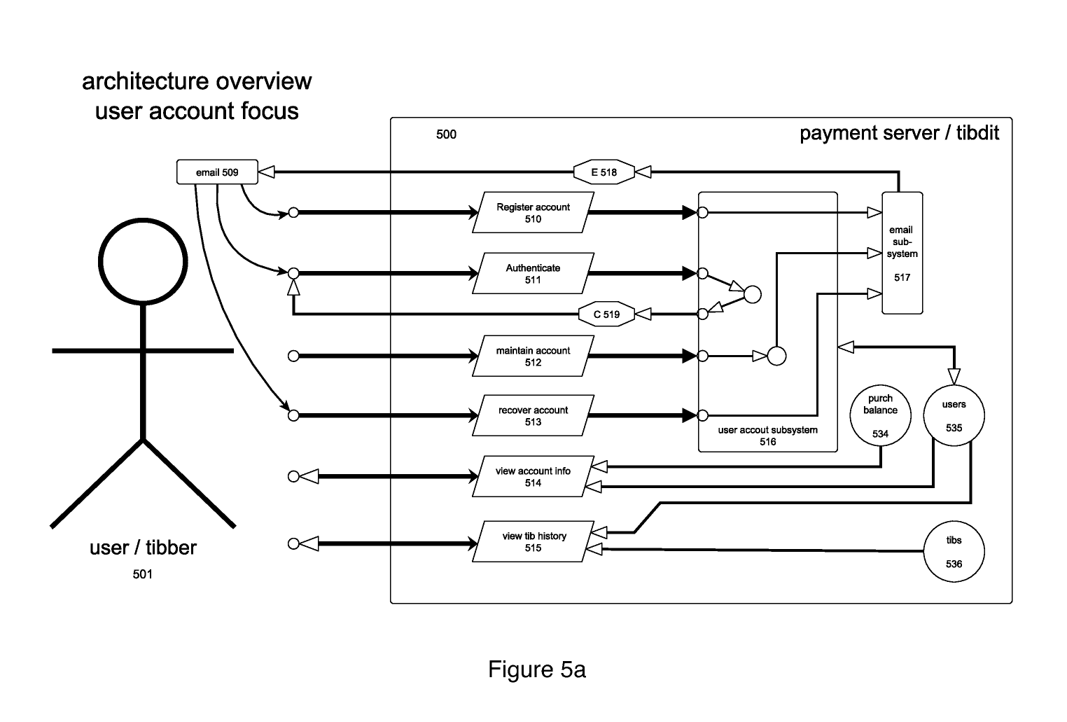

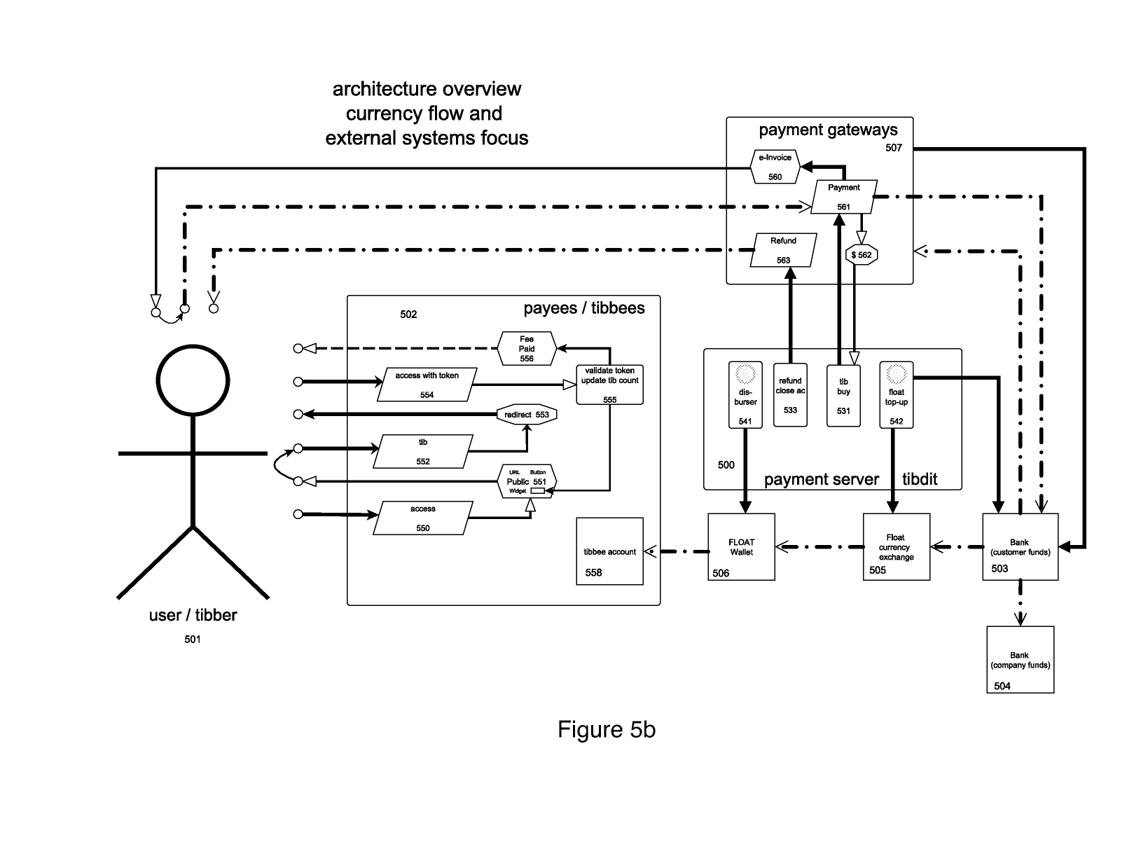

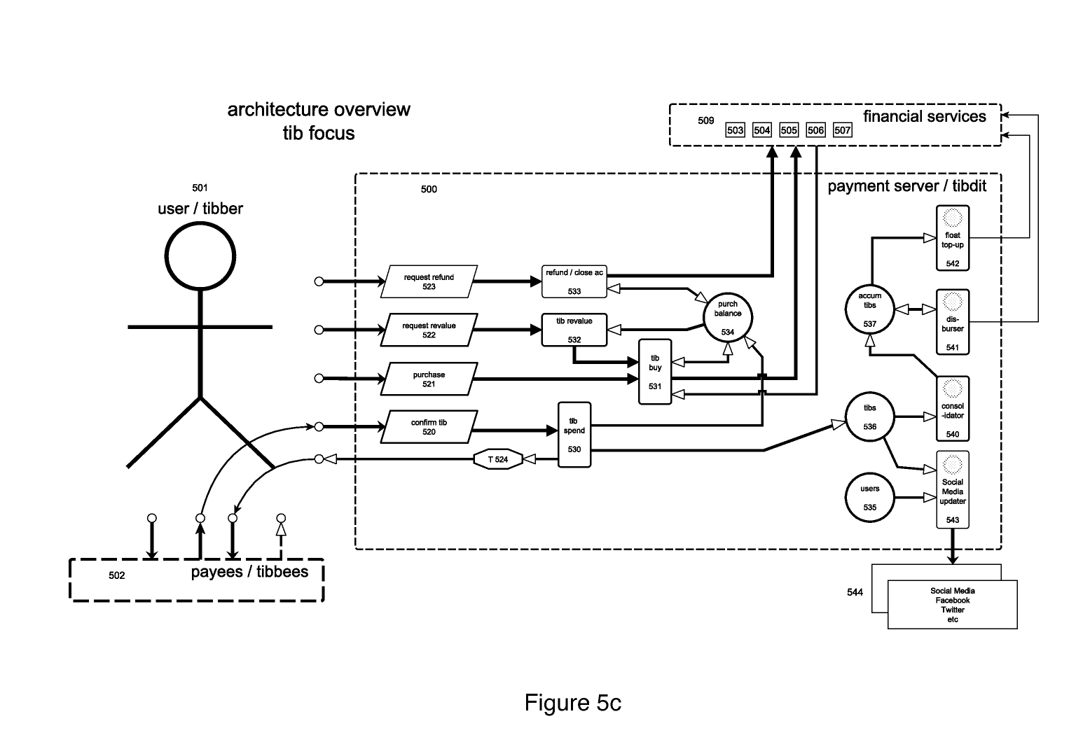

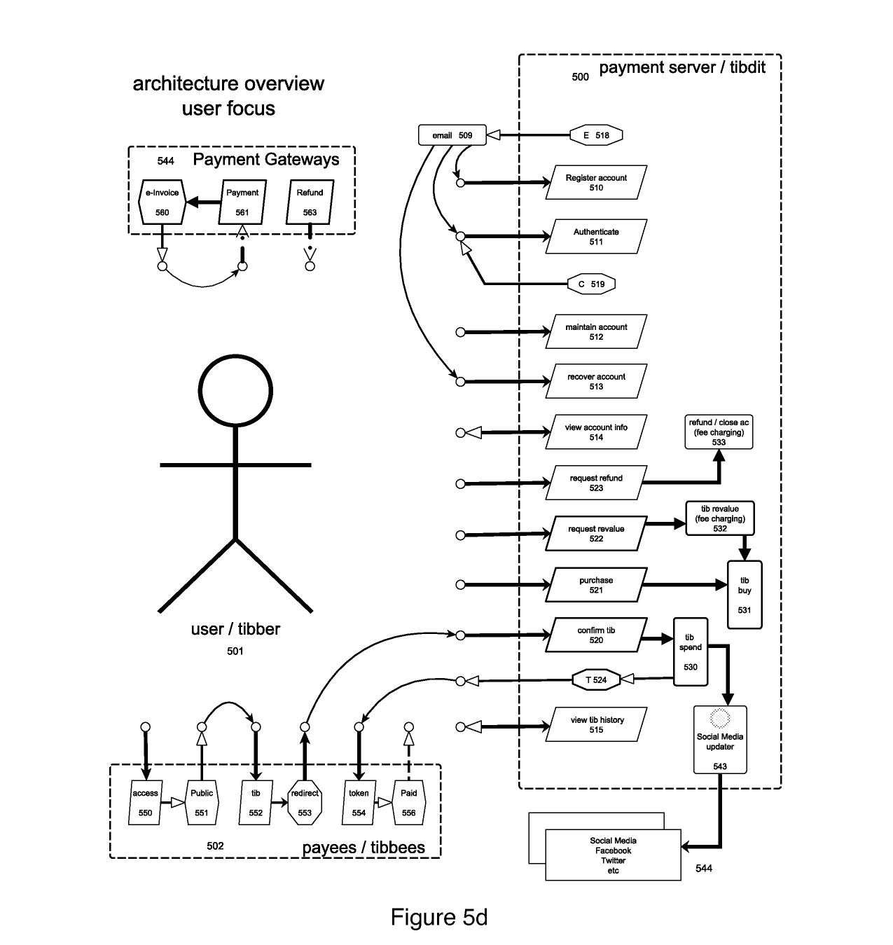

An embodiment of the invention will now be described with reference to FIGS. 4a, 4b, 4c, and 5. In this embodiment of the invention, the user or consumer will be termed the tibber 401, the payment server will termed tibdit 402, the payee will be termed tibbee 403, and payments will be termed tibs.

This embodiment will illustrate the use of the invention to create a micro-transaction platform enabling two-action (e.g. two-click) payment of gratuities and/or access fees (‘tibs’).

3rd-parties (‘tibbees’) publish a tib-initiator (e.g. a button on a website, a printed QR code) which encapsulates the payment mechanism and payment address to which tibs are to be sent, and send these details to tibdit (e.g. by incorporating this data in a URL).

The tib-initiator is an entity that the tibber accesses or triggers to initiate the payment of a tib from the tibber to the tibbee (e.g. a button on a web page).

The tib-initiator may include:
(a) a payment address in a standard form, which identifies a supported payment channel;
(b) [optional] a sub-reference allowing the tibbee to, for example, reuse the payment address for multiple services and identify received tibs accordingly;
(c) [optional] a URL pointing to any ‘social snippet’ content associated with the tib; and
(d) a private encryption key, or pointer to the same, to be used to encrypt the latter sent tib-token.

The first user (‘tibber’) action (e.g. click on tib-initiator) identifies the tibbee payment address by retrieving and accessing the encapsulated information (e.g. web browser redirect to the tib-initiator URL). This authenticates the tibber and confirms the payment of the tib to the tibbee.

The second tibber action (e.g. second mouse click) is performed in a secure environment (i.e. one controlled by tibdit).

Tibs have a previously set tibber-specific value, which is not revealed to the tibbee. A proof-of-tib token (‘tib-token’) is forwarded to the tibbee via the tibbers device (e.g. web browser) at the time of payment (‘tibbing’).

The tib-token is a digitally signed message delivered to the tibbee incorporating key transaction details except for the value of the tibbers tib. The tib-token enables the tibbee to take some action with regards their current interaction with the tibber. Such action could include sending a cookie to the tibber's web browser so that the effect of the tib persists beyond the tibbers tibdit session.

The tib-token may include:
(a) all the items within the tib-initiator;
(b) a timestamp;
(c) an indication of the number of tib-tokens sent to the tibbee with the same payment address and sub-reference; and
(d) a unique tib-token identifier.

Tibbers set a single value for all of a block of their tibs when depositing funds to purchase a block of tibs. Tibbers cannot set a value for individual tibs. Tibbees attempting to derive individual tib values or leveraging multiple-tibs to grant access to an entity may be blocked from receiving tib-payments.

The system accumulates tibs sent by all tibbers to a specific tibbee, and periodically sends the value (less any commission and/or fee paid to tibdit) of the accumulated tibs to the tibbee payment address via the payment mechanism as encoded in the tib-initiator.

Tibdit micro-transactions (tibs) may be specified in the tibber's preferred currency, rather than the tibbee's currency or any proprietary or arbitrary currency.

The tibber establishes their own value for their tibs from a set of available values within a defined range (or possibly just from a range) pertinent to their selected currency.

The tibber must purchase tibs in blocks, ensuring that after an initial tib, they are left with unspent tibs.

Tibs are intended to accommodate gratuity micropayments; tibbers are thereby encouraged to set a higher value-per-tib than they would if tibs were used exclusively for commercial transactions (e.g. access fees). However, the secure tib-token passed from tibdit via the tibber to the tibbee enable tibs to also be used for real-time commercial digital transactions (e.g. access to content or an automated service) where this is appropriate for a given tibbee. (i.e. the tibbee regards the average value-per-tib received above consideration of the value of each individual transaction).

Tibs may be re-factored (for a fee) should a tibber wish to adjust the value-per-tib for their balance of unspent tibs.

As tibbees are not aware of the value of each individual tib they must treat all tibbers equally, regardless of their tib value.

The tibdit platform is agnostic to the use of tibs, which must be purchased in blocks but can only be used individually. The tib-token is provided regardless, and it is up to the tibbee what actions they take, if any, as a result of receiving a tib-token. Processing by tibdit is identical whether the tib is an unacknowledged gratuity, or a fee to access some otherwise restricted content or service.

The tibdit platform prevents re-tibbing the same payment-address/sub-reference pair within 24 hours of an earlier tib. Further, the platform allows a tibber to resend a previously sent tib to re-establish access where necessary.

Tibbees are not required to create an account or otherwise register with tibdit, since all payment addressing is contained within the tib-initiator and passed to tibdit (e.g. via an HTTP request). All the tibbee needs do is publish a properly configured tib-initiator.

In relation to FIG. 4a, a method showing the process of the tibber 401 sending a tib to the tibbee 403 in accordance with an embodiment of the invention will be described.

In step 410, the tibber 401 activates a tib-initiator (e.g. clicks on a tib button on the tibbee's 403 website, snaps a hardcopy QR code on a wall of the tibbee's 403 premises).

The creation and publishing of a tib-initiator by a tibbee 403 is shown in relation to FIG. 4c described later.

In step 411, if the tibber 401 is unregistered, the tibber 401 provides registration details (e.g. email address and password) at step 412.

In step 413, if the tibber 401 is registered but not authenticated to tibdit 402 (e.g. web browser cookies cleared, or using a different digital device), the tibber 401 provides authentication details (e.g. email address and password) at step 414.

In step 415, if the tibber 401 has no unspent tibs, or if the tibber opts to purchase more tibs, the tibber 401 selects (i) currency, (ii) value-per-tib, and (iii) number of tibs in block (e.g. 20 tibs at USD 25 c each) at step 416.

In step 417, the tibber 401 pays tibdit 402 for block of tibs, including an administration fee, if any, via a payment service (e.g. PayPal, bitpay, bank).

In step 418, the tibber 401 confirms tib to be sent to the tibbee 403 from within a secure environment (i.e. tibdit 402 trusted).

In relation to FIG. 4b, a method showing tibdit 402 forwarding the tib value to the tibbee 403 in accordance with an embodiment of the invention will be described.

In step 420, tibdit 402 calculates the tibbee 403 payment due in the tibbee 403 payment currency from the tibber's 401 tib value currency, less commission and any fees (e.g. calculates 90of USD 25 c current value in BitCoin).

In step 421, tibdit 402 accumulates the total amount due to the tibbee 403 in the tibbee 403 payment currency since any previous payment to the tibbee 403.

In step 422, tibdit 402 triggers a payment to the tibbee 403 payment address if accumulated total due exceeds a particular value threshold, or the time since previous payment exceeds duration threshold.

In step 423, the tibbee 403 receives the funds deposited at the payment address encoded in the associated tib initiators.

In step 424, the tibbee 403 transfers the funds deposited at the payment address as they wish.

In step 430, tibdit 402 creates a proof of tib token.

In step 431, this token is transmitted to the tibbee 403 via the tibber 401.

In step 432, the tibbee 403 receives the token.

In step 433, the tibbee 403 validates the token

In step 434, the tibbee 403 takes action on the basis that a tib has been paid.

In step 435, the result of tib paid actions are received by the tibber 401.

In relation to FIG. 4c, a method showing the tibbee 403 publishing a tib-initiator in accordance with an embodiment of the invention will be described.

In step 440, the tibbee 403 establishes tibdit 402 supported mechanism to receive payments (e.g. obtains bitcoin address).

In step 441, the tibbee 403 configures one of more tib-initators encoded with (i) the payment address, and potentially other elements such as (ii) a sub-reference and (iii) a social snippet URL (e.g. (I) bitcoin address, (ii) article ID, and (iii) article URL).

In step 442, tibbee 403 publishes tib-initiator(s) (e.g. on a website, or printed in a barcode, or in text).

FIGS. 5a, 5b, 5c, and 5d shows an architecture for deploying a system in accordance with an embodiment of the invention.

FIG. 5a shows architecture for account management at the payment server/tibdit 500 by the user 501, including account registration module 510, user authentication module 511, account maintenance module 512, account recovery module 513, account information viewing module 514, and tib history viewing module 515.

FIG. 5b shows architecture for currency flow between the user/tibber 501, payment server/tibdit 500, payees/tibbees 502, and payment gateways 507 in accordance with an embodiment of the invention.

FIG. 5c shows architecture for micro-transaction/tib payments and tib management in accordance with an embodiment of the invention.

FIG. 5d shows architecture for user 501 actuation of payment of tibs to payees/tibbees 502 via the payment server/tibdit 500 in accordance with an embodiment of the invention.

In alternative embodiments, the tib-initiator and confirmation stages could be collapsed into a single active embedded widget displayed on the tibbable tibbee site, but entirely served from tibdit servers. This might reduce the tibber process from being two-click, to a single-click (providing the tibber is already authenticated and has unspent tips in their account).

Furthermore, tib-initiators may take other forms beyond website entities and QR barcodes (eg: near-field-communication (NFC) interactions, IVR (interactive voice response) systems, physical push buttons).

In addition, a single fixed-tib-value is possible (e.g. everyone in the U.S. has 25 c tibs) or at the other extreme, rather than providing a set of rounded values (currently across two order of magnitude e.g. 2.5 c thru $2.50), tib values could be set to any value within the range.

In one embodiment, tib-tokens could be passed to tibbers via alternate means (eg: email, printed matter) rather than through HTTP interactions from tibdit to the tibbee via the tibber's web browser.

In yet another embodiment, the system could be used for gratuities only without use of the tib-tokens.

In a yet further embodiment, the system could be primarily for access fees (using a different mechanism to ensure tibbers set a fair value for their tibs, such as offering only a single value per territory).

Accumulated tibs might be transmitted to tibbees using BitCoin, PayPal (using email address payment addresses), or via IBAN addresses for bank accounts.

Although, the accumulation of tibs is a practical way to avoid sending out every tib as it is spent, it can be envisaged that this is not a necessary element of the invention.

In one embodiment, a ‘single click’ process, eliminating the need to have a confirmation stage, is served entirely from the tibdit site for security assurance.

In one embodiment, tibdit may insert a CAPCHA for tibbers when possible automated tibbing is detected.

In another embodiment, real-time conversion from tibber currency to tibbee currency upon tibbing may be provided, thus avoiding the need to maintain floats for tibbee payment currencies (e.g. bitcoin).

In yet another embodiment, the ability for tibbers to request (for a fee) refactoring of a block of tibs to a different value-per-tib may be provided.

In one embodiment, tib-token verification by tibbees could be managed by tibdit servers—in the embodiment described in relation to FIGS. 4a, 4b, 4c, and 5 other than retrieving tibdits public signing key(s), this happens entirely on tibbees' systems,

In another embodiment, widget execution could occur on tibdit servers (potentially eliminating the need for a confirmation step).

In yet another embodiment, the tibber may be using custom mobile apps, telephone IVR, or any other mechanism of action where a tib-initiator could be technically implemented.

Potential advantages of some embodiments of the present invention are that:
i) Provision of true casual micro-transactions that function as both access-fees and gratuities with minimal friction for the user at the time of payment;
ii) Removal of the psychological barrier at the time of payment for the user of deciding what is an appropriate amount to pay;
iii) Removal of the difficulty for publishers in striking a fair price for micro-payment access-fees;
iv) Payment of micro-payments with just two user actions (i.e. mouse clicks) required of the user;
v) Content/service providers or charities can easily take receipt of micro-payments, payments, with no need to register with the payment server provider;
vi) Individual users' micro-payments are valued in the users' own preferred currencies, right up to the time of payment;
vii) The only contract/agreement required is between the user and payment server provider;
viii) Optional payee data embedded in the payee identifier enables the payment server to update user's social-media streams with ‘I just tibbed: ’status updates; and
ix) Optional payee data embedded in the payee identifier enables payees to track received tokens and payments by payee defined attributes (eg: author id, article id, date, etc).

While the present invention has been illustrated by the description of the embodiments thereof, and while the embodiments have been described in considerable detail, it is not the intention of the applicant to restrict or in any way limit the scope of the appended claims to such detail. Additional advantages and modifications will readily appear to those skilled in the art. Therefore, the invention in its broader aspects is not limited to the specific details, representative apparatus and method, and illustrative examples shown and described. Accordingly, departures may be made from such details without departure from the spirit or scope of applicant's general inventive concept.

1. A method of facilitating micro-transaction payments, including:
a) receiving a payee identifier at a device; and
b) actuating payment of a payment amount to the payee using the payee identifier in response to a first action by a user at the device;
wherein the payment amount is predefined by the user prior to receipt of the payee identifier by the device.

2. A method as claimed in claim 1, wherein the first action is a single action.

3. A method as claimed in claim 1, further including the step of:
prior to the first action, the device transmitting the payee identifier at a payment server in response to a second action by the user.

4. A method as claimed in claim 3, wherein, in response to receipt of the payee identifier by the payment server, information relating to the payment is transmitted from the payment server to the device for display to the user.

5. A method as claimed in claim 1, wherein payment is actuated in no more than two actions by the user.

6. A method as claimed in claim 1, wherein the user of the device initiates receipt of the payee identifier.

7. A method as claimed in claim 1, wherein the payee identifier is encapsulated within an electronically readable tag.

8. A method as claimed in claim 1, further including the step of:
the user at a device accessing a payment server to pre-define the payment amount.

9. A method as claimed in claim 1, wherein the payment amount is retrieved from a payment account associated with the user.

10. A method as claimed in claim 9, further including the step of:
the user at a device accessing a payment server to initiate the payment account.

11. A method as claimed in claim 1, wherein steps (a) to (b) are repeated for a plurality of payees and the payment amount is the same value for each payment.

12. A method as claimed in claim 1, further including the step of:
a payment server transferring a token to the device confirming payment.

13. A method as claimed in claim 1, further including the steps of:
the device transferring the token to the payee; and
the payee providing services to the user via the device in response to receipt of the token.

14. A method as claimed in claim 13, further including the steps of:
the device transferring the token to the payee;
the payee verifying the token; and
the payee providing services to the user via the device in response to successful verification.

15. A method as claimed in claim 14, wherein the token is digitally signed and wherein verification includes verifying the digital signature.

16. A method as claimed in claim 1, wherein the payee identifier is transmitted by the payee to the user.

17. A method as claimed in claim 1, wherein the payee identifier is encoded in a URL.

18. A method as claimed in claim 1, wherein the value of each payment amount received by a payee from a plurality of users are anonymised from the perspective of the payee.

19. A system for facilitating micro-transaction payments, including:
a device configured to receive a payee identifier and actuate payment of a payment amount to the payee using the payee identifier in response to a first action from a user of the device; and
a payment server configured to transfer payments from an account of the user to an account of the payee in response to instructions from the device;
wherein the payment amount is predefined by the user prior to receipt of the payee identifier by the device.

20. A computer readable storage medium having stored therein instructions, which when executed by a processor of a device cause the device to:
receive a payee identifier; and
actuating payment of a payment amount to the payee using the
payee identifier in response to a first action by the user;
wherein the payment amount is predefined by the user prior to receipt of the payee identifier by the device.
